(19) United States
(12) Patent Application Publication
(10) Pub. No.: US 2013/0225271 A1
(43) Pub. Date: Aug. 29, 2013

(54) AMUSEMENT DEVICES INCLUDING CUSTOMIZABLE GAMING PARAMETERS

(71) Applicant: CFPH, LLC, (US)

(72) Inventor: Lee Amaitis, Las Vegas, NV (US)

(73) Assignee: CFPH, LLC, New York, NY (US)

(21) Appl. No.: 13/773,915

(22) Filed: Feb. 22, 2013

Related U.S. Application Data
(60) Provisional application No. 61/602,849, filed on Feb. 24, 2012.

(51) Int. Cl. G07F 17/32

(52) U.S. Cl. CPC G07F 17/326; G07F 17/323; G07F 17/3288
USPC 463/25

(57) ABSTRACT

Some embodiments include a fantasy sports game. In some embodiments, an expected performance value may be determined. In some embodiments, a set of players may be determined, one or more accomplishments may be determined, a parameter may be determined based on the participants and the accomplishments, and a game may be formed. Various other embodiments are described.

### CROSS REFERENCE TO RELATED APPLICATIONS

This application claims priority to U.S. provisional application 61/602,849, which is hereby incorporated herein by reference.

### FIELD

Some embodiments may relate to sport events, games based on actions of players in live sport events, other types of events, and/or other types of games.

### BACKGROUND

Gaming may include risking an amount of money that one event will or will not happen. Fantasy sports may include one or more games related to events taking place in real sports games.

### BRIEF DESCRIPTION OF THE FIGURES

FIG. 1 shows an apparatus for playing a game, according to some embodiments.

FIG. 2 shows an example fantasy sports system according to some embodiments.

FIG. 3 shows an example process that may be performed in some embodiments.

FIG. 4 shows an example interface that may be used in some embodiments.

FIG. 5 shows an example method that may be performed in some embodiments.

### SUMMARY

The following should be understood to be embodiments, not claims.

A. A method comprising: receiving, by a computing device, a set of participants chosen by a user; receiving, by the computing device, an accomplishment chosen by the user; determining, by the computing device, odds for a game that is based on whether the set of participants will achieve the accomplishment in a plurality of events, in which the odds determination is based on historic data about performance of the participants; offering, by the computing device, the game for play with the odds to the user; receiving, by the computing device, an acceptance of the offer from the user that identifies an amount of money risked through play of the game; determining, by the computing device, an outcome of the game based on whether the set of participants achieved the accomplishment in the plurality of events; and determining, by the computing device, whether to provide a payment to the user based on the outcome.

A.1. The method of claim A, in which the set of participants are players from across a plurality of events. A.2. The method of claim A, in which the events include sporting events. A.3. The method of claim A, in which the game includes a fantasy sports game. A.4. The method of claim A, in which the historic data includes information indicative of each participant's ability to contribute to the accomplishment in prior events to the plurality of events. A.5. The method of claim A, in which offering includes presenting information about the odds to the user through a user interface of a mobile device. A.6. The method of claim A, in which the outcome includes winning the game if the participants achieved the outcome and a determination to provide the payment is made in response to the determination that the outcome includes winning the game. A.7. The method of claim A, further comprising receiving an amount of money to play the game from the user. A.8. The method of claim A, in which the accomplishment includes a number of points earned in total by the set of players in the plurality of events. A.9. The method of claim A, further comprising providing the payment to the user.

A.10. The method of claim A, in which the set of participants includes a plurality of participants. A.10.1. The method of claim A.10, in which each participant plays in only one of the plurality of events and the set of participants collectively plays in all of the plurality of events. A.10.2. The method of claim A.10, in which the accomplishment includes a plurality of accomplishments that each apply to a single respective one of the plurality of participants. A.10.2.1. The method of claim A.10.2, in which the outcome is a winning outcome if each participant achieved the single respective accomplishment of the plurality of accomplishments that applies to the participant. A.11. The method of claim A, in which the accomplishment includes achievement of a goal in a designated time period. A.11.1. The method of claim A.11, in which the outcome is a winning game if the goal is achieved in less than the time period.

B. An apparatus comprising: a computing device; and a non-transitory medium having stored thereon a plurality of instructions that when executed by the computing device causes the computing device to: receive a set of participants chosen by a user; receive an accomplishment chosen by the user; determine odds for a wager that the set of participants will achieve the accomplishment in a plurality of events, in which determining the odds includes determining based on historic data about performance of the participants; offer the wager with the odds to the user; receive an acceptance of the wager from the user that identifies an amount of money wagered; determine an outcome of the wager based on whether the set of participants achieve the accomplishment in the plurality of events; and provide a payment to the user based on the outcome.

### DETAILED DESCRIPTION

### I. Example Embodiments

Some embodiments may facilitate a player in defining a game. Such a game may include a single player and/or multiplayer game that is played through a gaming entity. A player may define a event on which the game is based and/or one or more desired components of the game. The gaming operator may present information and/or determine outcomes for such player-specified games.

Colloquially, gaming may be referred to as wagering but it should be understood that embodiments are not limited to the statutory definition of wagering that is limited to games of chance but rather may include games of skill, fantasy games, games of chance, and/or any other type of games and therefore the term gaming is used when discussing some embodiments rather than the term wagering. Gaming may include a risk of an amount of money that some event will happen. Such risk may be skill and/or risk based, booked and/or pari-mutuel, and/or take any form desired. Gaming may include paying a fee to enter into a contest that is based on the occurrence of an event. The winner of such a contest may be provided with an award (e.g., money based on a sum of contest entry fees). Wagering may be used herein to refer to such skill or risk based gaming in some instances and should not be understood to be limited to one or the other type of gaming unless specified otherwise. Gaming may include wagering, betting, risking money, paying an entry fee to a contest, and/or any other form of gaming as desired. Various embodiments may apply to any type of gaming in any combination and/or arrangement.

To facilitate play of a user-specified game, a gaming operator may present information through an interface to allow a player of the game to define characteristics of the game (e.g., an accomplishment that must be met or must not be met to win the game). Other parties may enter the game through such a gaming operator and/or the game may be played as a single player game (e.g., with the gaming operator as an opponent/house). The gamin operator may determine outcomes and facilitate payments based on the user-specified game. Accordingly, various players may play games through the gaming operator based on the same event(s) and/or team(s) and have different outcomes because of user-specified characteristics (e.g., accomplishments). A gaming operator may perform and desired functions to facilitate such user-specified gaming in various forms in some embodiments.

### Fantasy Game Examples

In some embodiments, a game may be a fantasy game. It should be recognized that embodiments are not limited to fantasy games but that examples are given in terms of a fantasy game in a non-limiting manner. Moreover, examples of fantasy games and operation are also given in a non-limiting manner and other embodiments may include any fantasy or non-fantasy game or event on which a wager is placed as desired. U.S. patent applications 61/479,539, 12/605,826, 13/160,746 and 61/668,245 are hereby incorporated herein by reference. Some example fantasy games and/or wagers that may be used in some embodiments are described in these references.

Various examples are given in relation to a popular variation of fantasy events, namely fantasy sports, but it should be understood that various embodiments may include any fantasy event. In some embodiments, fantasy sports may provide a manner for a participant to act in a role similar to a coach and/or general manager. In some embodiments, a participant may be given the ability to draft, create, trade, dismiss and/or otherwise manage a fantasy team.

The events, participants, and/or players to which a fantasy event may be related may include any desired events, participants, and/or players. For example, some events may include political events (e.g., elections), sporting events (e.g., football, baseball, basketball, hockey, soccer, rugby, golf, tennis, automotive racing, animal racing), competitions (poker, test taking, rock throwing, tree growing), other events, and so on. For example, some participants and/or players may include politicians, human players, animal participants, robots, natural phenomena, plants, physical things, and so on. It should be recognized that fantasy event competitions may be constructed based on any kind of activity. For example, fantasy competitions may be constructed based on an activity in which participants in the fantasy competition may compete vicariously based upon observations or statistics regarding some underlying activity (e.g., wind speed, elections, tree growth, baseball, and so on). A team should be understood to include a club (e.g., soccer club), an individual in a one or more sport, one or more individuals in one or more events, and/or other variations of similar concepts. A fantasy team for an activity may include one or more members that each correspond to one or more respective real and/or active participants in the activity. For example, a fantasy team for a sport may include one or more players of the sport. The players may include active players in a real league for the sport. The players may include active league players from one or more real sports league.

In some embodiments, a member of a team may include a portion of a real team. For example, in some embodiments, in addition to and/or as an alternative to a particular member of a team being selected for a fantasy team, a portion of a team may be selected for a fantasy team. For example, a defensive team of a football team may be selected for a fantasy team regardless of actual members of the defensive team. Accordingly, scoring of such a fantasy team may relate to actions and/or performance of the entire defensive team rather than a single member of the team.

In some embodiments, a participant in a fantasy sports game may select members to form a fantasy team for a sport. In some embodiments, a participant may select or “draft”, currently active real-life players to form a fantasy team. Accordingly, a fantasy team for a sport may include a plurality of members that each correspond to a respective player of the sport. In some embodiments, a selected member for a fantasy team may include a group of players (e.g., the defense of a particular football team may be a member of a fantasy team, the outfield of a particular baseball team may be a member of a fantasy team, and so on).

In some embodiments a plurality of participants may form a fantasy league and select players in the fantasy league. Each player in the league may pay a fee to join the league. The fee may be pooled by a gaming operator for use in award payment, booked by the gaming operator as a wager, and/or paid to the gaming operator as a fee. The fantasy league may be referred to as a fantasy game, and the winning participant in the league may receive some award (e.g., from the gaming operator, from pooled funds held by the gaming operator, based on a fee paid to join the league, etc.). As an example, in a fantasy football league, a plurality of league participants (e.g., two) may each select one or more professional football players (e.g., 5) onto their fantasy team and pay a fee to be part of the league (e.g., $10). Based on performance of those selected players in real sports events, the participants may earn points in the fantasy sports league and a winner may be determined and paid an award (e.g., $20 minus some rake taken by the gaming operator).

It should be recognized that the form of risk and/or relationship between and/or among the parties to such a game and/or a gaming operator may take any form. Terms such as form a game are used in a broad sense to refer to any such form. For example, a wager may be established directly between two participants, a contractual obligation may be established between a gaming operator and each of the participants separately, a pari-mutuel pool may be established into which money may be placed, a book of bets may be formed into which money may be placed, and/or any desired method of forming a game may be used. In some embodiments, to form a game, each participant in a game may pay a contest entry fee to enter the contest. Such fees may be pooled together and used to pay a winner. A data structure may record information regarding formed games, and/or other information about gamers and/or games.

In some embodiments, a central authority (e.g., a gaming operator) may establish and/or enforce rules for a fantasy sports game. Such a central authority may include a casino, a server, a house, a book maker, a web site, and/or any other desired gaming operator. Such a central authority may be referred to as a commissioner, and/or a treasurer. In some embodiments, multiple entities may operate as separate parts of such a central authority (e.g., one treasurer and one commissioner). In some embodiments, the central authority may be configured to determine outcomes of a game, accept wagers, adjust balances, accept money, determine if a game condition is satisfy, establish leagues, maintain accounts, pay winnings, perform a method to facilitate functionality described herein, and so on. A central authority may include one or more computing devices (e.g., servers, processors, mobile devices, and so on) configured to perform one or more actions in order to facilitate gaming.

One example of a game that may be used in some embodiments may include a Cantor 5 (or Cantor any number) game that may be offered by Cantor Gaming and/or Cantor Data Services. In such a game, a league may be opened (e.g., by player and/or operator). Some non-limiting examples are given in terms of a 2 person league, but a league may be any number of users (e.g., 2, 5, 10, etc.). When a league is full (e.g., players equal to the maximum number have joined), the league may be closed and a game may be formed between/among the players that joined the league. So, for example, a user may desire to play a $50 dollar Cantor 5 game and so may form a two person Cantor 5 league with a $50 buy-in (e.g., risked amount, contest entry fee) by entering information through a website. A second user may see the formed league through the website and may join the league. At that point, the players may be entered into a $50 game with one another. Cantor may take a cut of the buy-ins for offering the fantasy service and may use the rest of the buy-ins to pay an award to a winner of the game. Cantor may pool the buy-ins into a pool that may be used to provide a winner some award.

At some point before a start of a game and/or some other closing trigger, each player may be required to select members for their fantasy team. Members may be chosen in any manner (e.g., round robin, individually, and so on). In some embodiments, each player may independently choose a team so that a team of one player does not affect to team of another player and that each player may have some or all same players on their team. A gaming operator (e.g., Cantor) may set an expected point total for each team (e.g. based on historical performance of each player on the team). To set such an expected point total Cantor may intentionally skew the number lower to encourage players to choose higher performing players. Based on the assigned expected value of each team, a spread may be created between the team. For example, if team A is expected to earn 95 points and team B is expected to earn 97 points, then a 2 point spread between the teams may be formed. A winner may be determined for the game based on the play of real games so that if Team B, for example, wins by more than two points, team B is the winning team because it beat the spread.

In some embodiments, a system may be configured to provide one or more participants with fantasy sports contest-related information. Fantasy sports contest-related information may include any suitable information associated with one or more fantasy sports contests. For example, fantasy sports contest-related information may include information regarding a participant's one or more rosters, a participant's standing in one or more fantasy sports contests, point tallies associated with a participant in one or more fantasy sports contests, information regarding the number of trades that a participant may make, information regarding the amount of fantasy money available to a participant for contracting players for a roster, information regarding deadlines to make trades or to perform any other suitable task associated with one or more fantasy sports contests, an outcome of a fantasy game and/or any other suitable information.

In some embodiments, a system may be configured to provide one or more participants with information regarding one or more real life games. Such information may include information regarding real-life athletes (e.g., names, statistics, etc.), real-life sports leagues (e.g., game schedules, standings, etc.), real-life sporting events (e.g., baseball games, golf tournaments, tennis matches, etc.), sports arenas, weather information, sports commentary, or any other suitable information regarding real-life sports or events.

In some embodiments, various types of fantasy games may be played. For example, a head-to-head type game may be played in some embodiments. A head-to-head game may include a participant competing against one or more participant (e.g., another player, a casino or other gaming operator) in a game (e.g., over a week, over a season and so on). In some embodiments, the fantasy team that accumulates the most points in the game period based on performance in actual games may win the game. As another example, a “rotisserie league” game may be played in some embodiments. In such a game, participants associated with respective fantasy teams compile won-lost records by competing head to head against each of the other teams in the league. A winner in such a system may be determined based on the performance of active real life athletes in real life games. It should be recognized that any desired game type and/or scoring system may be used in various embodiments.

In some embodiments, a playoff type game may be played. For example, participants may play one or more games during a regular season of fantasy games that may or may not correspond to a regular season of an underlying sport. Participants may be eliminated during the regular season in some embodiments. Participants may acquire points and/or wins during the regular season. Participants remaining at some point in the game, with a most number of points and/or wins at some point in the game may qualify for a playoff type game. The playoff game may be similar and/or different to a “regular season” game. For example, a participant may be able to select members for their playoff team and engage in games in the playoffs with the selected fantasy team. A winning of the playoff may be larger than a winning of a regular season. Players that may be selected may be limited to those players that are participating in a playoff in an underlying game. Different rules regarding budgets, uniqueness, and/or scoring may be used in a playoff game. One or more games may include a user-specified accomplishment. For example, a group (e.g., head to head, pool, rotisserie, league, etc.) of players may play a group game. Each player may identify an accomplishment and a team. The team may win if the team achieves the accomplishment. Each player with a winning team may be a winning player in the game. A gaming operator may set some characteristic that determines how the money is split based on difficulty of achieving the accomplishment (e.g., players with more difficult accomplishments may gain more money from a pool). A single player game may be played in which similarly an odds or other characteristic may be determined by a house that facilitates play of the game.

Some embodiments may include a pari-mutuel pool for a league. For example, each player that enters a team into a league may pay money. The winner of the league may win at least a portion of the pool of money.

It should be recognized that a fantasy sports game need not be limited or restricted in time. For example, a fantasy sports contest may last an entire season, a portion of the season, a definite period of time (e.g., one month, two weeks, three days, one hour, etc.), the duration of a particular event (e.g., Wimbledon, etc.), a portion of a particular event, or any other suitable period of time.

In some embodiments, a fantasy sports contests may include event game options. For example, fantasy sports contests may involve a participant wagering on whether particular outcomes will occur (e.g., whether a particular golfer will make the next put). Such games may be played against a house, another participant (e.g., a participant against whom a team to team game is played, and so on).

It should be recognized that these examples are only one non-limiting examples and that any manner of fantasy gaming and/or or other gaming/wagering may be used as desired.

### Example Interface Discussion

Some embodiments may include presenting an interface through which a player may form a team for such a game and/or receive/enter any information about such a game. Such an interface may allow a player to select members of the team from a set of players of a real sport (e.g., players that are expected to play in an upcoming game) and/or an accomplishment for a game. Such an interface may present information about each possible member to add to a team to allow a player to better perform a selection of members. For example, an interface may display an expected number of points that each possible addition to a team may be expected to score in a game. Such an interface may identify if one or more possible members has been chosen as part of a casino team and/or other team (e.g, that may eliminate the selection by a player for a game against that particular team in some embodiments). Such members may be excluded from an interface in some embodiments if rules of such an embodiment prevent the member form being added to a team for some reason (e.g., the member is in another team, there are already a number of common members to teams and addition of a member would exceed a maximum threshold of common members, a member is expected to be injured, and so on). Such an interface may identify a number of times a member has been selected for a team and/or an amount of money that has been risked on and/or against teams with a member.

In some embodiments, one or more characteristics for a game involving a player's team, a casino's team and/or any number of other teams may be determined based on members of each respective team and/or an accomplishment selected by a player. For example, in some embodiments, odds, moneylines, point spreads, a handicap and/or any desired characteristic may be determined for a game of one team against another team based on expected performance of members of one team compared to members of another team. Various examples of determining characteristics are given herein.

In some embodiments, such information may be displayed in an interface related to a selection of a team. For example, a handicap or other information (such as odds, payout ratios, etc.) may be displayed in an interface for the selection of a team. Such information may identify how a selection of one player or another player has affected or would affect a handicap if added to a team. For example, a handicap may identify a current handicap at a current makeup of a team even if the team is not complete or finalized. As members are added and/or change, the handicap may adjust to reflect the next state of the team.

In some embodiments, a player may form their team and then select a casino team and/or may form and/or select opponent teams in any combination order or manner as desired (and there may be no opposing team at all). An interface may identify a handicap and/or other characteristic associated with games involving each of the possible casino and/or opponent teams and/or the selected player team. In some embodiments, one or more teams may not be available for selection in a game against a player team based on rules of a venue (e.g., if a casino team includes more than a number of common members with a player's team, the casino team may be excluded from an interface in response to a determination of such common members).

In some embodiments, in response to a selection of a player's team and/or a opponent's team (e.g., a casino team), such characteristics may be displayed to a player though an interface. For example, in response to a formation of a player's team and a selection by that player that the player desires to enter into a game setting that team against an accomplishment being achieved by the team, an indication of an odds (or other characteristic) for such a game may be identified through an interface to the player. The interface may allow the payer to accept, alter, set a money amount, reject, and so on the game having the identified characteristic. For example, an interface may identify that a player may enter into the game with the player's team being required to earn 8.5 points in order to win the game with a 3 to 1 odds. A player may be able to choose between achieving the accomplishment or not achieving the accomplishment with same or different odds. The player may enter a dollar amount in response to such an indication to play a game, press an accept button to enter into the game, reject entry into the game, and/or take any other actions through such an interface.

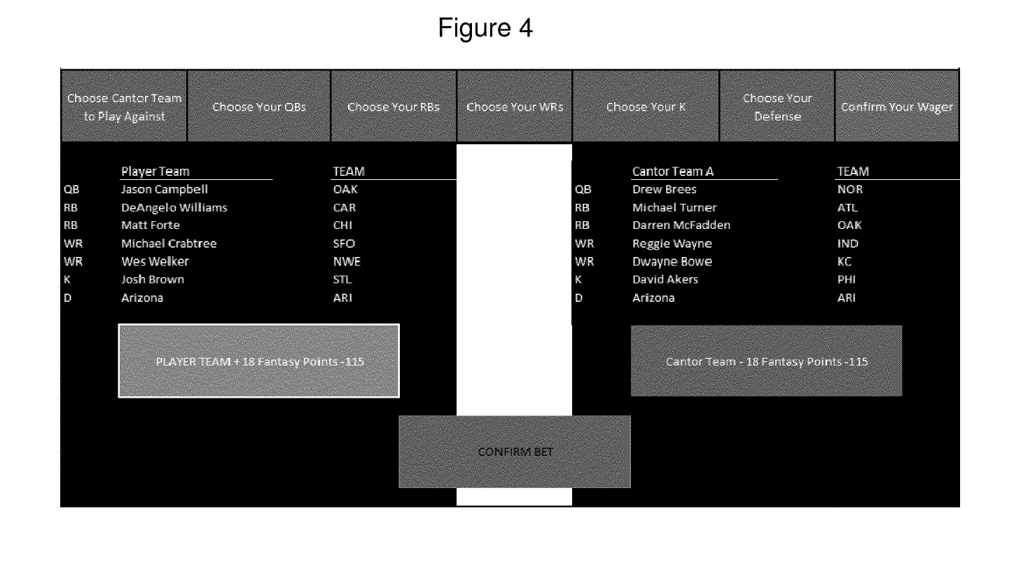

FIG. 4 illustrates an example interface through which a user may enter information regarding a game. For example, a user may choose members of a team, view odds, choose a side to game on, confirm a game, and so on through such an interface. In the illustrated interface, a user has selected a player team and chosen a casino team for the player team to play against. The casino and player team share a defense. A handicap of 18 points has been determined (e.g., the player team has a 1 point advantage), and a money line of −115 has been determine (e.g., $115 must be game to win $100).

It should be recognized that while some embodiments may be described in terms of a game against a casino and/or a wager against a casino, that other embodiments may include a game against another player and/or a game involving a team formed by another player and/or casino (e.g., casino formed team, player-specified accomplishment). Elements of one embodiment may apply to another embodiment in any combination (e.g., an interface that includes information such as handicaps about possible opponent teams may be included in a plurality of embodiments).

### Example Systems

One example fantasy sports system is described in U.S. Pat. No. 6,371,855 to Gavriloff, which is hereby incorporated herein by reference. Another example fantasy sports system is described in U.S. Pat. No. 7,001,279 to Barber, which is hereby incorporated herein by reference. Yet another example of a fantasy sports system is described in U.S. patent publication number 2008/0287198 to Callery, which is hereby incorporated herein by reference. An example of a fantasy sports system that may include additional interactive elements is described in U.S. Pat. No. 7,351,150 to Sanchez, which is hereby incorporated herein by reference. One variation of a fantasy sports game is given in U.S. patent publication 2005/0064937 to Ballman, which is hereby incorporated herein by reference. An example of a fantasy sports betting system that may provide additional advice to players is described in U.S. patent publication 2007/0060380 to McMonigle, which is hereby incorporated herein by reference. An example commissioner system for a fantasy sports system is described in U.S. patent publication number 2008/0200254 to Cayce, which is hereby incorporated herein by reference. An example system for managing assets and transactions related to a fantasy sports system is described in U.S. patent publication 2008/0215168 to Charchian, which is hereby incorporated herein by reference. An example of pari-mutuel wagering related to fantasy sports is described in U.S. patent publication number 2009/0023495 to Koustas, which is hereby incorporated herein by reference.

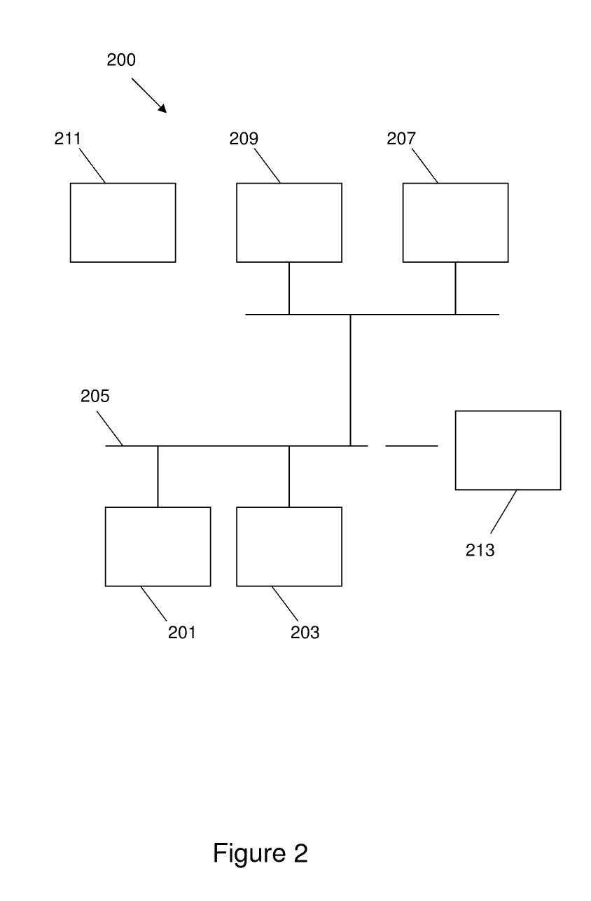

It should be understood that the above are merely illustrative elements of fantasy sports contests. Any other suitable arrangement or approach may be used. It will further be understood that the nature of the fantasy sports contests may vary depending on which activity or sport is involved or based on any other suitable criteria. Some embodiments may include a gaming operator that includes one or more systems, such as a fantasy sports system. One example fantasy sports system 200 is illustrated in FIG. 2. As illustrated, fantasy sports system 200 may include a gaming system 201, an event server 203, a network 205, a client computing device 207, a staff computing device 209, a mobile device 211, and an event source 213. Gaming system 201 may be configured to perform any desired services related to a game. For example, gaming server 201 may receive one or more indications related to a game (e.g., achievement, team, money). gaming system 201 may match players into a game, may form games, may audit games, may determine/provide outcomes of games, may transmit data for interfaces, may act as treasurer or house for a game, may provide gaming opportunities, may perform a method such as one described herein, and so on. In some embodiments, gaming system 201 may allow a participant to enter into a game against a house. In some embodiments, gaming system 201 may allow a participant to enter into a gaming involving another player. It should be recognized that gaming system 201 may include any number of systems, computing devices, and/or any desired components. In some embodiments, gaming system 201 may include an exchange-based gaming system. One example exchange based gaming system is described in U.S. patent application Ser. No. 10/831,375 to Burgis and entitled System and method for managing risk associated with product transactions, which is hereby incorporated herein by reference. In some embodiments, bid and/or offers for a game may be received and games may be formed based on the bids and/or offers.

It should be recognized that the above example of a gaming system is given as a non-limiting example only. In some embodiments, a gaming system 201 may receive an indication of a fantasy sports team on which a game is desired. The gaming system 201 may receive an accomplishment for the team to define the game. Gaming system 201 may form a game defined by the team and the accomplishment. Such a game may include one or more gaming system defined characteristics (e.g., odds, payout ratios, handicap, etc.) that may be based on the team and/or the accomplishment.

In some embodiments, a casino or other venue may act as an intermediary (e.g., gaming server) between players. For example, a casino may enter into two offsetting games with two players. In some embodiments, a window of time may be set for particular gaming opportunities (e.g., gaming opportunities for particular teams and accomplishments). The gaming server may accept some games that offset one another (e.g., one for achieving the accomplishment and one against achieving the accomplishment) so that risk is minimized by the gaming server. Some examples of a gaming portal that may be used in some embodiments are described in U.S. patent application Ser. No. 12/979,546, which is hereby incorporated herein by reference.

Event server 203 may be configured to receive and/or process information regarding events. The events may include real life sporting events. For example, events may include hits, runs, completed passes, incomplete passes, interceptions, catches, bases stole, blocks, three point shots, steals, fumbles, shots on goal, and/or any other information. Events may include events at a recent game and/or events from non-recent games. Events may be received substantially simultaneously as the event happening.

Event server 203 may determine fantasy sport outcomes and/or points based on the events. For example, in an embodiment in which a participant receives a point if a real life player that corresponds to a member of the participant's fantasy sports team scores a touchdown, then the event server may be configured to add a point to the participant when information identifying that the player scored the touchdown is received. In some embodiments, event server 203 may be configured to maintain historical records of event information. Such information may be used periodically to determine outcomes and/or points. In some embodiments, event information may be used to determine performance values for a fantasy sports team.

Some examples of receiving and processing event information are described in U.S. patent application Ser. No. 12/367,566 to Plott and entitled Mobile Gaming Alert, which is hereby incorporated herein by reference.

Network 205 may include any desired communication network or networks. Network 205 may include wired portions and/or wireless portions. Network 205 may include a local network, the internet, and/or any desired network. Network 205 may allow portions of system 200 to communicate among one another and/or outside systems.

Client computing device 207 may include any desired computing device. Client computing device may be configured to allow a participant to enter and/or access information regarding a fantasy sports game. For example, client computing device 207 may include a network connected computer at a casino, at a remote location, and/or at any desired location. Client computing device 207 may include a special purpose computer configured to display sporting statistics, game feeds, game option and so on on one or more displays (e.g., that display an interface such as one described herein). Client computing device 207 may include input and/or output elements for money related to one or more games (e.g., a ticket in ticket out device, a credit card device, a cash dispenser, a cash intake element, etc.). Client computing device 207 may communicate with one or more other elements of system 200, such as gaming system 201 to submit or receive information. System 200 may include any number of client computing devices that may allow any number of participants to play any number of fantasy sports games.

Staff computing device 209 may include a computing device configured to be operated by a staff member of a gaming establishment, such as a casino. Staff computing device 209 may include a device at a sports book at which a participant may tell a staff member about a desired game, the staff member may enter the information to create a game, a bid for a game, a fantasy sports team, an accomplishment, and so on.

Mobile device 211 may include any desired mobile computing device. For example, mobile device 211 may include a mobile telecommunications device such as a cell phone, a mobile gaming device and so on. An example mobile gaming device is described in U.S. patent application Ser. No. 11/868,013 to Lutnick and entitled Game of Chance Processing Apparatus, which is hereby incorporated herein by reference. Other example mobile gaming devices may include tablet computers, smartphones, and so on. Mobile device 211 may communicate over a wireless network, such as a portion of network 205. Mobile device 211 may allow a participant to enter and/or receive information related to a fantasy sports team and/or game.

Event source 213 may include any desired source of information related to events. For example, event source 213 may include a television, an rss feed, a news feed, a news paper publication, an announcer, a web site, a log of events, a phone system, a television, and so on. Event source 213 may be part of system 200 or may be separate form system 200 (e.g., a system run by a sports league or television channel such as ESPN, NFL.com, and so on). Event source may be connected to the internet and provide information about events to system 200.

Various elements of a system may be considered a module. For example, an interface module may receive, transmit, and/or perform any actions for allowing interfaces of any type to function; a gaming module may determine information, process games, determine outcomes, and/or perform any actions for allowing gaming functionality; an accounting module may function to manage accounts; and/or any collections of modules (e.g., that match or do not match elements and/or functions portions that may be described herein) may be used in some embodiments.

It should be recognized that system 200 is given as a non-limiting example only. Various embodiments may include additional, alternative, fewer, different, and so on components as desired. For example, some embodiments may include a web server, an authentication server, and or other servers as desired. It should be recognized that system 200 may not be a singular system, but rather may include various components that may be owned, operated, and/or manufactured by different entities. System 20 and/or one or more components thereof may operate to facilitate gaming such as by performing one or more methods described herein or otherwise.

### Example Methods

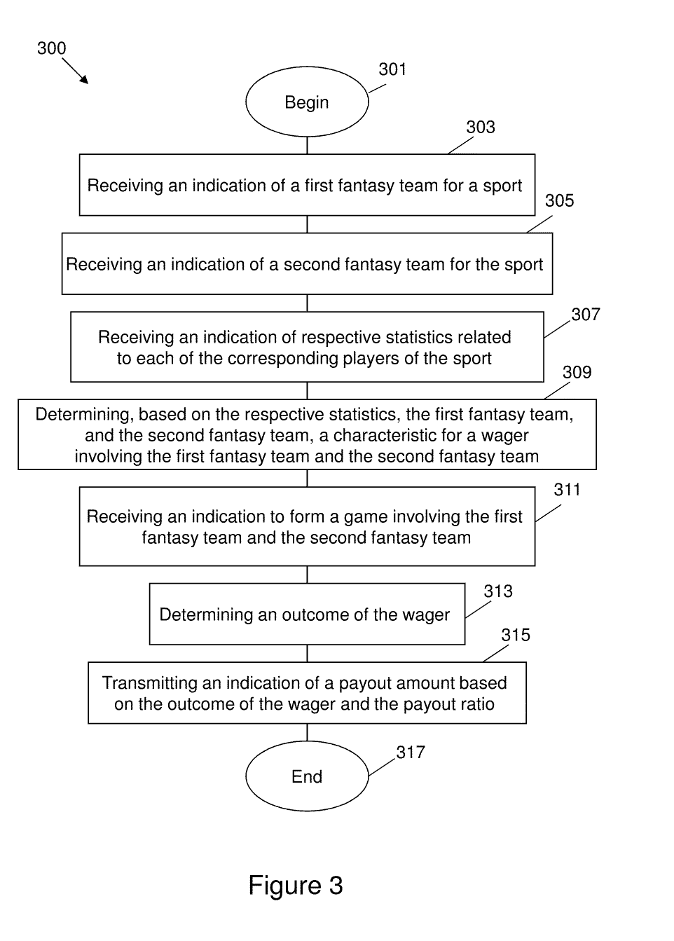

FIG. 3 illustrates an example process 300 that may be performed in some embodiments. Process 300 may begin at block 301. Process 300 may be performed by system 200 and/or one or more components of system 200 such as gaming system 201, event server 203, a processor, and/or any other device.

As indicated at block 303, process 300 may include receiving an indication of a first fantasy team for a sport. The indication may be received from a computing device (e.g., a device operated by a participant, a client computing device a mobile computing device, staff computing device). In some embodiments, the first fantasy team may include a first plurality of members that each correspond to a respective player of the sport, as discussed above. Such a first team may include a casino team and/or a player team in some embodiments.

In some embodiments, the indication may include an indication of each of the members of the fantasy team. In some embodiments, the indication may include an indication of a position for one or more of the members of the fantasy team (e.g., quarterback). In some embodiments, an indication of a fantasy team may include an indication of an outcome of a draft. In some embodiments, an indication of a fantasy team may include an indication of a selection of members of the fantasy team (e.g., by a participant of a fantasy sports game, by a casino as part of a selection of one or more casino teams). Various examples of forming a team are described above and it should be recognized that an indication of such forming may be received in any number of ways in some embodiments.

Various examples of rules for a team involving uniqueness and other elements are described above. Some embodiments may include verifying that the team meets requirements.

In some embodiments, at least two of the first plurality of members may correspond to a same first player of the sport. It should be recognized that in various embodiments, any number of the members may correspond to the same first player. The members may be assigned same or different positions from one another and/or the real player, in various embodiments. In one example, all members on a team may correspond to a same first player. In some embodiments, two or more members of a team may correspond to respective players that play in a same position in the sport even if the sport only allows one player to play that position at one time. For example, in some embodiments, a fantasy team may include multiple members that correspond to players that play as quarterbacks.

It should be recognized that some embodiments may include assigning members to a position and some embodiments may not include assigning members to a position. Such assignment to a position may and/or may not be affected by non-unique members. In some embodiments, non-unique members may not be assigned positions at all and may earn points based on actions of the player regardless of position played by the player. In some embodiments, non-unique members may be assigned positions and may earn points based on actions of the player that are relevant to each assigned position. As indicated at block 305, process 300 may include receiving an indication of a second fantasy team for the sport. Such receiving may be substantially similar to the receiving of block 303. Such receiving may be from a player of a fantasy sports game (e.g., a player that desires to play their selected team against a casino's selected team in a fantasy sports matchup). The second fantasy team may include a second plurality of members that each correspond to a respective player of the sport. The second fantasy team may include a casino team and/or a player team.

In some embodiments, at least one of the second plurality of members corresponds to the same first player of the sport discussed above. In some embodiments, for example, the first fantasy team includes one or more of the first player and the second fantasy team includes one or more of the first player. A combined number of times the first player is included in any number of times may not be limited in some embodiments. A combined number of times the first player is included in any number of times may be limited in some embodiments. In some embodiments, a number of members of a first team and a second team that are common may be limited (e.g., a second team may be rejected or otherwise not allowed to be selected if the number of common members exceeds a threshold number).

Although some fantasy games may include two or more teams, others may include only a single team and block 305 is given as a non-limiting example of games in which two or more teams are part of a game.

As indicated at block 307, process 300 may include receiving an indication of respective statistics related to each of the corresponding players of the sport. Statistics may include any information that may describe happenings in one or more sport. For example, statistics may include a statistic related to past performance of one or more players of the sport. For example, a statistic may include a number of completed passes, a number of yards run last game, a number of games played in a career, a current earn run average, a percentage of free throws made, and/or any desired information. Such an indication may be received from an event source (e.g., from a historical database of an event source). It should be recognized that any information regarding one or more members of one or more teams may be received in various embodiments. Such information may include information about prior games.

As indicated at block 309, process 300 may include determining, based on the respective statistics, the first fantasy team, and the second fantasy team, a characteristic (e.g., a payout ratio, a handicap, other odds, a minimum risked amount, a maximum risked amount, and so on) for a game involving the first fantasy team and/or the second fantasy team (e.g., in games involving two or more teams). A payout ratio and/or odds may define an amount that a participant associated with each respective team may be paid if they win a game involving the two teams. In some embodiments determining the payout ratio may include determining the payout ratio so that a team with players that have better statistics may receive a lower payout than a team that includes players with worse statistics. A handicap may include an amount of points that one team must win against another team to be considered a win by the one team. A handicap may be determined such that a team with players that have better statistics may have to win by at least some number of points to be considered a winning team.

Some embodiments may include determining characteristics related to a game and/or (possible or actual) member of a fantasy team. For example, some embodiments may include determining an expected number of points that a team and/or member may earn in a game. For example, a fantasy team selected by a player and/or casino may include a number of members. A determination of a number of points that each team and/or member may earn in a fantasy game may be determined in some embodiments. In some embodiments, a determination based on such expectation may be used to determine a odds, moneyline, payout ratio, handicap, and/or other characteristic of a game.

In some embodiments, a skew may intentionally be introduced to such a determination of a characteristic. Such a skew for example may include intentionally lowering an expected points earned by a member of a fantasy team and/or fantasy team in whole than would be expected from statistics. Such a skew may encourage players of a game to select members of the team that are higher performing than they would normally pick (e.g., in cases in which player's prefer to have an underdog team).

A determination of an expected number of points for a member and/or team may include determining a number of points that the member is expected to earn based on historic performance of the player. The data may include information indicative of each participant's ability to contribute to the accomplishment in prior events to the plurality of events. The historic performance may include performance from all prior games, recent prior game, prior games against an opponent (e.g., team, coach, player) that the member will be playing an upcoming real game that may be used as a basis for determining an outcome of a fantasy game, history of home and/or away games, and so on. Various weightings may be given to historic information to make such a determination. For example, recent games may be given more weight than non-recent games in determining an expected points. If an upcoming game is an away game, away games may be given more weight than home games. Games against same opponents may be given more weight than games against different opponents. It should be recognized that any combination of weights and information may be used in determining an expected number of points for a particular member as desired and that examples given are non-limiting. Such information may be displayed through one or more interfaces in some embodiments.

In one particular non-limiting example, player X may have an expected number of points to be earned in an upcoming game. In the past two seasons, player X may have earned an average of 70 points each game. In the current season, the player may have earned 60 points for two of the three games. One of the three games may have been against team A and member may have earned 80 points. Such information may be received in some embodiments. A determination of an expected points may be made by an algorithm that takes such information into account. For example, an expected number of points may be determined such that expected points are equal to 70 times A (e.g., 0.33)+70 times B (e.g., 0.33)+60 times C (e.g., 0.1)+60 times C (e.g., 0.1)+80 times D (e.g., 0.13). In this example embodiment such an expected number of points may equal 68.6. In some embodiments, such an expectation may be skewed down intentionally (e.g., by a set percentage, by a number of points, if it is great than a threshold, etc.) to, for example 65 points.

In some embodiments, a sum of points of each member of a team may be used to determine an expected number of points for a team. For example, a sum of a casino team member may be used to determine an expected number of points that the casino team will earn. As another example, a sum of expected points for each member of a player team may be used to determine an expected number of points for a player team to earn in a game.

Some embodiments may include determining a characteristic for a game based on such characteristics of a team. For example, a characteristic of a game may be determined based on expected points of one or more teams and/or one or more members. For example, a handicap may be determined for a game involving two teams based on a comparison of expected pointed for each of the teams. For example, as a non-limiting example, if a first team has an expected number of points of 100 and a second team has an expected number of points of 110.5, a handicap may be 10.5 points. Such a handicap may include an amount of points that a second team may be required to win by in order for a game on the second team to be a winning game. Such information may be presented to a user through an interface (e.g., an interface for selecting a team, an interface for making a game, and so on). In some embodiments, a house edge may be added to one or more sides or teams as desired.

In some embodiments, such an expected points may be used to determine an odds and/or payout ratio (e.g., in combination with an accomplishment). For example, an odds that are worse for the player may be determined if the accomplishment is to achieve points that are less than the expected points and may be better for the player if the accomplishment is to achieve points that are greater than the expected points.

It should be recognized that various examples of characteristic determination are given as non-limiting examples only. Other embodiments may include any desired methodology. For example, in some embodiments, actual expected events of a real game may be determined (e.g., expected passing yards, expected touchdowns), and based on such expected events, an expected score may be determined. As another example, some embodiments may include adjusting a characteristic based on other games (e.g., if many players the thing a particular team will win, the team may be given an increase in expected points; if a player that has a winning record thinks that a team will win, the team may have an adjustment made to the expected points, and so on).

In some embodiments, determining the payout ratio may include determining an expected performance value for the first team and/or the second team. An expected performance value may include an indicator of expected performance based upon statistics of players on a team. An expected performance value may include an indication of an expected number of points that a team may earn based on the statistical data. In some embodiments, a payout ratio may be based on a comparison of the two expected performance values (e.g., a ratio of the two values, a formula applied to the two values, etc.) and/or a comparison of an achievement and an expected performance value.

It should be recognized that while points earned in a fantasy game are given as examples of accomplishments and/or characteristics that may be determined, that any desired element may be determined based on any characteristic of an event (e.g. length of game, number of hits, etc.) that may or may not be translated into points through game rules.

Some embodiments may include displaying one or more of the expected performance values and/or the payout ratio to a participant (e.g., a user associated with one of the teams). Such information may be used, for example to adjust a team, to verify a game, and so on.

As indicated at block 311, process 300 may include receiving an indication to form a game involving the first fantasy team and/or the second fantasy team (e.g., in embodiments where there are two or more teams in a game). The indication may be received from one or more client computers, from a gaming system, and so on. The game may include a game that a first team may achieve an accomplishment, beat a second team (e.g., over a period of time, in a game, in a season, and so on), achieve an accomplishment before a second team, out achieve an accomplishment by more than a second team, and/or vice-a-versa. The game may include a game that one fantasy team will outperform another fantasy team over a period of time with or without reference to an accomplishment selected by a player. In some embodiments, a participant associated with one or more of the fantasy teams may view information related to the game and/or verify the game. Some embodiments may include receiving an amount of money to play a game from a player (e.g., from an account, in cash, etc.).

In some embodiments, various game related actions may be performed, such as debiting and/or crediting accounts, obtaining signed contracts, collecting chips or money, and so on.

As indicated at block 313, process 300 may include determining an outcome of the game. The outcome of the game may be determined based on happenings of one or more events. For example, events related to members in the team(s) may be used to determine points for each team, as described above. A comparison of the points may be used to determine the outcome. In some embodiments, determining the outcome may include determining the outcome based on events in one or more games involving the members on one or more fantasy team. Some embodiments may include receiving an indication of the performance of the members (e.g., from an event source).

As indicated at block 315, process 300 may include transmitting an indication of a payout amount based on the outcome of the game and the payout ratio/odds/moneyline. Such a payout amount may be determined based on the outcome and the payout ratio. Such an indication may be made to a client. In some embodiments, such an indication may include an indication that a payment was made. In some embodiments, such an indication may be displayed on a display. In some embodiments, such an indication may include an indication to a staff member to pay an amount. In some embodiments, such an indication may include an indication that an amount should be transferred from one account to another account.

In some embodiments, an outcome includes winning the game if the players in fantasy team achieved the accomplishment and a determination to provide a payment may be made in response to a determination that the outcome includes winning the game.

Process 300 may end at block 317. It should be recognized that process 300 is given as a non-limiting example only. It should be recognized that method 300 is given as a non-limiting example only. Other embodiments may include additional, alternative, differently ordered, more, fewer, different, and/or same actions as desired.

For example, in some embodiments, a player may enter two or more teams for a game and/or two or more accomplishments for a game. A game may be based on both such teams and/or both such accomplishments. For example, a player may define a game and a first team may achieve a first accomplishment and a second team will achieve a second accomplishment, that a first team will achieve a first accomplishment before a second team achieves a second accomplishment, that a first team will achieve a first accomplishment but a second team will not a achieve a second accomplishment, and so in any combination and number of teams and/or accomplishments. As another example, a player may not establish a team but rather a gaming operator may establish a team and a player may establish an accomplishment for that team.

Some embodiments may include voiding one or more games based on actions that occur after a game is formed. For example, if a member of a team involved in a game is injured, the game may be voided. In some embodiments, if a member of one of the teams does not play in a game the game may be void. Different rules may apply in different games and/or to different members. For example, a game may not be void if a kicker does not play in a football game because there is no kicking opportunity in a game, and/or a defense does not play in a football game because there is no defensive opportunity, but a game may be voided if a quarterback does not play.

It should be recognized that while some embodiments may describe determining odds, pay ratios, handicaps, and/or other characteristics of one or more games involving pairs of teams, single teams, accomplishments, and so on, some embodiments may include determining characteristics for a league and/or for any number of teams in a matchup. For example, a three team matchup may include determining odds that any one of the three teams wins and/or assigning handicaps for each team with respect to another team, and/or determining payout ratios for each team if they win, and so on.

It should be recognized that while some embodiments may include determining a single money line and/or handicap, some embodiments may include determining a different handicap for one team than another and/or a different money line for one team or another. Some embodiments may include an even money line, no handicap, and so on in any combination as desired. For example, in some embodiments there may be no handicap and there may be different money lines.

It should be recognized that wile various embodiments are given in terms of football, other embodiments are not limited to football. Some embodiments may include other sports and/or other events as desired and may include different rules for different events as desired. For example different sports may include different numbers of players, different game characteristics, and so on.

It should be recognized that reference to a casino are non-limiting and may include any intermediary, gaming operator, sports book, and so on.

It should be recognized that various orderings of actions are non-limiting. For example, a player may select a team before a casino team is presented and/or a casino team may be presented before a player selects a team. In some embodiments where a player selects a team first, casino teams that do not include selected players may be displayed but other casino teams may not be displayed.

It should be recognized that while various embodiments may be referred to as having a casino perform one or more actions, that such an identification of a casino is given as a non-limiting example only. In other embodiments, any entity and/or entities may perform any desired action sin any combination. For example, a gaming provider, a sports book, a server, a processor, a computer system, and so on may perform one or more actions.

### Example Choose N Embodiments

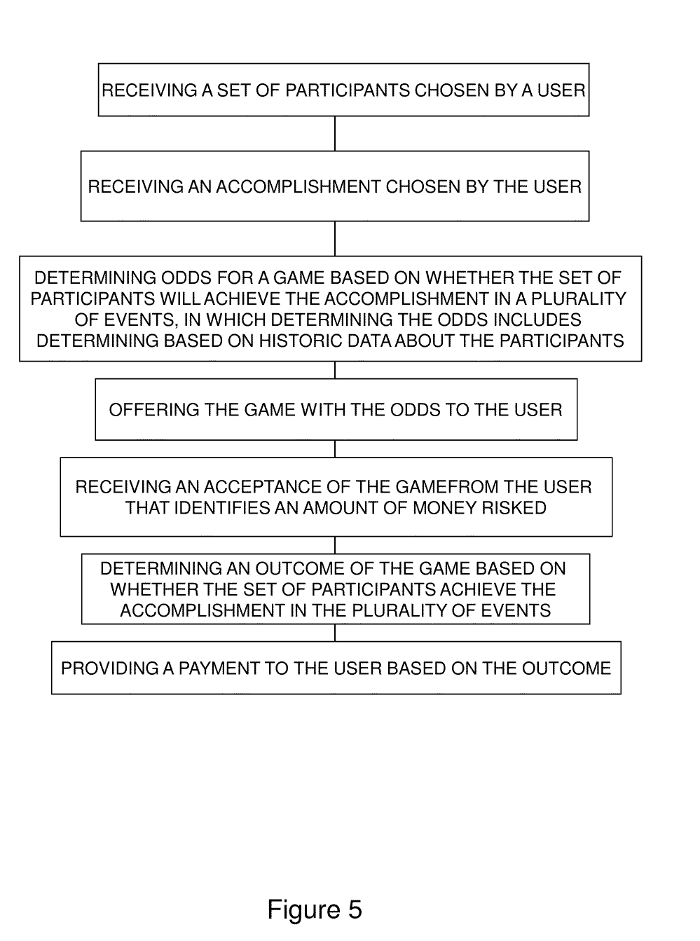

Some embodiments may include facilitating a game on whether one or more participants achieve one or more accomplishments in one or more events. For example, in some embodiments, a user may select a set of participants (e.g., one or more players in a sports game), select one or more accomplishments (e.g., number of points scored by the players), and/or play a game for an amount of money that the set of participants will achieve the accomplishment. For example, in some embodiments, a gaming operator (e.g., a computing device of a sports book) may determine parameters for the game (e.g., odds based on the participants and/or accomplishments), determine whether the set of participants achieves the accomplishment in one or more events, and/or make payouts for winning games (e.g., based on determined odds and/or an amount of money risked). FIG. 5 illustrates one example method that may be performed in some embodiments (e.g., by a computing device of a gaming operator such as a gaming server run by a sports book and/or one or more mobile or other devices that may interact with a computing device such as smartphones through which users may play games with a sports book).

Some embodiments may include determining a set of participants. The set of participants may include one or more participants. In some embodiments, each participant plays in only one of a plurality of events and the set of participants collectively plays in all of the plurality of events. In some embodiments, users may select one or more participants that they desire for a game through an interface (e.g., an interface of a mobile device that allows the users to play games). In other embodiments, a house may determine a set of participants in other ways (e.g., choose a set randomly, choose a set for each game, choose a set based on current players in on going and/or upcoming games, establish one set of players for all games, and so on). Determining a set of participants may include receiving the set of participants (e.g., from a user and/or operator of a house).

In some embodiments where users may select their own set of participants, a user may choose from available participants through an interface and/or enter participants through an interface. The available participants may include any set of participants such as a set of participants that are competing in an upcoming and/or on going event. For example, some embodiments may allow a user to select players that are playing in a game on a coming weekend (e.g., any baseball players that will be playing in any MLB game to be held in a next weekend).

In some embodiments, a set of participants may include any desired number of participants. For example, a set may be limited to some maximum number, may be required to have some minimum number, may be any number greater than or equal to one, may be a required number, may be chosen by a user, may be chosen by a house, may include five participants, seven participants, ten participants, and so on.

In some embodiments, a set of participants may include participants in a same side or team and/or participants from a variety of sides or teams. For example, in some embodiments, a set may be limited to participants on a single team. Such a single team may be restricted to a team that a user plays a game regarding. For example, a user may be offered a choose n type game as an adjunct to a standard game based on a team and the choose n game may be limited to members of the team. Similarly, in some embodiments, a set of participants may be limited to a game that a user may or may not have otherwise played. Some embodiments may or may not include limits on the type of participants (e.g., a single quarterback, any number of quarterbacks).

Some embodiments may include facilitating selection of the set of participants. For example, some embodiments may include determining available participants for the set (e.g., based on information about which participants are participating in one or more events), providing those participants for selection through a user interface (e.g., presenting participant names through a computing device interface for selection by a user, limiting selection to available participants), receiving a selection of the set of participants (e.g., receiving information identifying the participants over some communication network), and/or perform any desired actions.

Some embodiments may include selecting a set of participants for a game. For example, a house may choose participants for a plurality of games based on a desired makeup of a set and available participants. Rather than and/or in addition to selecting their own participants, players may use some or all of a house-made set as part of a game.

Some embodiments may include determining one or more accomplishments. In some embodiments, users may select one or more accomplishments that they desire for a game through an interface (e.g., an interface of a mobile device that allows the users to play games). In other embodiments, a house may determine one or more accomplishments in other ways (e.g., chosen randomly, chosen for each game, chosen based on a set of participants, established for all games, and so on). Determining one or more accomplishments may include receiving the one or more accomplishments (e.g., from a user and/or operator of a house).

In some embodiments where users may select one or more accomplishments, a user may choose from available accomplishments through an interface and/or enter information defining one or more accomplishments through an interface. Available accomplishments may include any type of accomplishment defined by any information. Different accomplishments may be available for different sets of participants (e.g., based on the size of the set and/or based on the type of the set). For example, some accomplishments may be available for players of certain games but not players of other games (e.g., a number of hits may be available for a set of baseball players, a number of points scored may be available for a mixed set of baseball and football players, a yards passed may be available for a set that includes a quarterback, and so on).

In some embodiments, some accomplishments may include one or more variables and/or conditions that define the accomplishments. For example, an accomplishment may be achieved if some condition that defines the accomplishment is met. Some example conditions may include a winning game, a completed pass, a homerun hit, a number of yards run, a number of runs earned, a number of votes earned, a number of strokes in a golf game, a number of punches thrown, and so on. A variable may include a quantity that may be used as a comparison to determine if an accomplishment is met. For example, an accomplishment may be achieved if some comparison to a variable has a desired characteristic. Some examples may include if a number of runs is greater than a variable, if a number of hits is greater than a variable, if a number of strokes is less than a variable, if a number of players are involved in a winning game, and so on.

In some embodiments, one or more accomplishments may include any number of accomplishments that may apply to the set of participants in any combination of ways. In some embodiments, the one or more accomplishments may include a single accomplishment, a single accomplishment per participant in the set, a plurality of accomplishments, and so on. In some embodiments, an accomplishment may be participant specific (e.g., a participant may either individually achieve or not achieve an accomplishment, a participant may either hit a number of balls in a set of games or not). In some embodiments, an accomplishment may be set specific (e.g., a set of participants may either collectively achieve or not achieve an accomplishment, a set of participants may either collectively hit a number of balls in a set of games or not). In some embodiments, an accomplishment may include any combination of collective or individual elements (e.g., a number of participants of the set of participants achieves or does not achieve an accomplishment individually or collectively, any subset such as the best performing of a set each hits and/or collectively hits a number of balls in a set of games or not).

In some embodiments, accomplishments may include accomplishments that apply to different types of participants and/or events in any combination. For example, a set of participants may include a golfer, a quarterback, and a baseball player. Some corresponding example accomplishments may include each participant is a winner, the golfer has fewer than X strokes in a game, the quarterback throws at least Y yards, the baseball player earns at least Z hits, at least W of the prior accomplishments is achieved, and so on.

In some embodiments, an accomplishment includes a number of points earned in total by a set of players in a plurality of events. In some embodiments, an accomplishment includes a plurality of accomplishments that each apply to a single respective one of a plurality of participants. In some embodiments, an outcome of a game is a winning outcome if each participant achieved the single respective accomplishment of the plurality of accomplishments that applies to the participant. In some embodiments, an accomplishment includes an achievement of a goal in a designated time period (e.g., score 2 runs within 5 minutes). In some embodiments, an outcome of a game is a winning game if the goal is achieved in less than the time period.

Some embodiments may include facilitating selection of one or more accomplishments. For example, some embodiments may include determining one or more accomplishments that may be selected from (e.g., based on a type of participant in the set, based on a number of participants in a set, based on accomplishments that may be achieved in upcoming events, determining variables and/or accomplishments that would produce odds within a range), providing those accomplishments for selection through a user interface (e.g., presenting accomplishment identifiers through a computing device interface for selection by a user, limiting selection to the determined one or more that may be selected), providing an interface through which a user may enter a variable that may define an accomplishment (e.g., a text box or other control that may allow entry of a number, limiting selection to the determined variables that may be available), receiving an identification of one or more accomplishments (e.g., receiving information identifying the accomplishment and/or variable over some communication network), and/or perform any desired actions.

Some embodiments may include selecting one or more accomplishments. For example, a house may choose an accomplishment for a game based on the participants in a set. For example, in a baseball example, for each member of the set some additional number of hits may be added to a variable that defines an accomplishment based on the number of hits the participants hit a day. Such a number may be based on a historic skill of a participant (e.g., good hitters may add more hits). In some embodiments, a selection may be made such that expected odds for the game are within a desired range (e.g., so that odds based on historic data show that there would be an even chance of achieving the accomplishment). For example, for an accomplishment of a number of hits being made collectively by a set of participants, a determination may be made of the average number of hits that each player has made (e.g., in recent games, in all games, in games against a upcoming opponent, etc.). An accomplishment may be set based on such a sum of excepted hits. Rather than and/or in addition to selecting their own participants, players may use some or all of a house made accomplishment in a game.

It should be recognized that while some examples are given in terms of one or more participants achieving one or more accomplishments being chosen by one or more users, that such examples are non-limiting. Some embodiments, for example, may include games based on an accomplishment not being achieved, games based on some number of accomplishments of a set of accomplishments being achieved, games based on any combination of achievement and non-achievement, and so on.

As another example, some embodiments may include establishing a fixed one or more accomplishments and/or set of participants. Accordingly, a group of people may be in games with same parameter but different participants all hoping that their participants achieve the accomplishment, a group of people may be in games with the same participants hoping that their participants will achieve different accomplishments, and/or a group of people may be in games with the same accomplishment and participants.

Some embodiments may include determining one or more parameters for a game. Such a determination may be made in response to determining one or more accomplishments and/or the set of participants. For example some embodiments may include determining an odds for a game. Other embodiments may include determining a minimum and/or maximum money amount that may be played in a game (e.g., risked, paid as an entry fee to a contest), a payout table, a spread game paradigm, a point spread, and/or any other desired parameter that may define a game.

Determining a parameter may include determining an odds for a game based on a set of participants and/or one or more accomplishments. Such a determination may be based on an expectation of the likelihood of the set of participants achieving the one or more accomplishments. For example, an expected chance that a chosen set of participants will achieve a chosen one or more accomplishments may be determined based on an analysis of historical events. For example, for a game based on a number of hits being made by a collective set of participants in sports games on a upcoming day, a determination may be made of the percentage of times that such a collective of players would have achieved that accomplishment in the past based on their prior performance (e.g., number of hits in prior games). Such a percentage of times may be used as a basis for the odds of a game (e.g., may be the odds, may be the odds with an adjustment applied to include a house edge).

It should be recognized that any analysis of historical data may be used in any manner to determine an odds for a game. Some embodiments may store happenings in events (e.g., sports games) so that they may be consulted for odds determinations. Some embodiments may receive historic happenings and/or statistics to be used for odds calculations (e.g., in response to a need to make an odds calculation).

Some embodiments may include offering a game that is defined by the determined one or more parameters and is based on whether the set of participants achieves the one or more accomplishments. Such an offering may be made in response to a determination of the one or more parameters. For example, some embodiments may include presenting an interface through which a user may enter into a game that the set of participants will achieve the accomplishment. Such a game may include an odds defined by the parameters. A user may be able to operate such an interface to enter into the game with the house.

Some embodiments may include receiving information about the game and forming the game in response. For example, a computing device may receive information identifying that an offered game is accepted by a user. The information may include an identity of the user. The information may include an amount of money on which the game is based. The game may be formed between a house and the user for the amount of money. Although gaming for money (e.g., risking money to win more money) is described in some embodiments, it should be recognized that other forms of gaming may not involve money (e.g., play for free, play for points, play with tokens, etc.).

Some embodiments may include determining an outcome of a game. For example, a feed of information identifying events in one or more events may be received and analyzed. Such analysis may result in a determination of whether the set of participants has achieved the one or more accomplishments. Such a determination may be made in response to a determination that the one or more events have ended. Some embodiments may include making a payment based on whether the outcome is a winning outcome. For example, if the outcome is a winning outcome, a payment from a house based on the odds may be made to an account of the user who played the game. Such a payment may be made in response to determining that the outcome is a winning outcome.

It should be recognized that while examples are given in terms of pregame gaming in whole sports events against a house, that such examples are non-limiting only. For example, events may include any type of events whether sports related or not (e.g., elections, card games, casino games, tv shows, etc.)

For antoher example, some embodiments may include a game related to an event that is placed after an event begins (e.g., an in game game). Being in a game may affect an odds or other parameter determination. For example, in the hits example, some number of hits and/or hit attempts may have already occurred. Such information may be used to determine the odds of the game.

As another example, some embodiments may include a game based on a portion of an event. For example, an accomplishment may be based on an inning, a half, a period of time, and so on. For example, a number of yards that a player rushes in a half of a football game may be a basis of an accomplishment.

As yet another example, an exchange system may be used for the formation of games. Such exchange gaming may include a house as an intermediary with whom games are played that relate to matching offers from other users. Such an exchange system may directly form games between the other users and not against the house. To facilitate such exchange gaming, one or more elements of a game may be offered from one user, a house may determine some parameter based on such elements, and the game may be published on an exchange. A second user may accept the game and the house may form the game in response to the matching bid and offer.

As still another example, some embodiments may include a spread game in which a spread by which a team achieves an accomplishment or misses achievement of the accomplishment may affect a payment or loss in the game. Rather than an amount of meet or miss an achievement, some embodiments may be based on time of the achievement. As examples, some embodiments may include paying a user ore for a win that includes a win by more than a threshold amount, paying a player more for each point over an accomplishment that is achieved by a team, paying a player more for a team achieving an accomplishment faster than some time period, and/or vice-a-versa or in any combination or alternative desired.

One example of a game may include a game based on whether a set of baseball players will earn a number of hits in sports games played on a particular day. A system may identify the baseball players that are starting in the games played on that day to a user through an interface. The user may select a desired number of players from the identified players. The system may allow the user to enter a variable of the number of hits. The user may enter the number of hits that he would like to guess that the players will make. The system may receive that information and determine an odds for the game based on a history of hits by the players in prior games. The system may identify the odds to the user. The user may accept the game and enter an amount of money to play the game. The system may form a game with the user, subtract funds form the user's account, determine that the game is a winning game based on events in the games, and pay the user to the account a payment for winning the game.

Another example may include a game based on a number of passes that a set of quarterbacks may complete in games over a week. A set of starting football players may be presented to a user by a system for games in a coming week. The user may select a number of quarterbacks (e.g., only quarterbacks may be presented and/or the user may simply choose to make an all quarterback game, the passes game may be part of a multipart game that may include non quarterback components). The system may determine odds for the game, accept an amount of money, and make outcome determination as desired.

As yet another example, a user may choose to play a game based on a number of strokes that a set of golfers in a day of a golf tournament will take that day. A system may determine odds for such a game, determine outcomes of such a game, and so on as desired. It should be recognized that while examples are given in terms of single sports and single accomplishments, that other embodiments may include multi part games with any number of accomplishments and/or any number of event types in any combination (e.g., strokes in golf and passes in football in a single game).

The following sections provide a guide to interpreting the present application.

### II. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### III. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article. The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites. No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other. All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth□, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VII. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VIII. 35 U.S.C. §112, paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### IX. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### X. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### XI. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XII. Cards

Playing cards have been in existence for many years. Although there are many types of playing cards that are played in many different types of games, the most common type of playing cards consists of 52 cards, divided out into four different suits (namely Spades, Hearts, Diamonds and Clubs) which are printed or indicated on one side or on the face of each card. In the standard deck, each of the four suits of cards consists of 13 cards, numbered either two through ten, or lettered A (Ace), K (King), Q (Queen), or J (Jack), which is also printed or indicated on the face of each card. Each card will thus contain on its face a suit indication along with a number or letter indication. The King, Queen, and Jack usually also include some sort of design on the face of the card, and may be referred to as picture cards. Other types of playing cards are described herein, but it should be recognized that various topics may apply to any, some, and/or all type of playing cards.

In some cases, the 52 card standard playing deck also contains a number of extra cards, sometimes referred to as jokers, that may have some use or meaning depending on the particular game being played with the deck. For example, if a card game includes the jokers, then if a player receives a joker in his “hand” he may use it as any card in the deck. If the player has the ten, jack, queen and king of Spades, along with a joker, the player would use the joker as an Ace of Spades. The player will then have a Royal Flush (ten through Ace of Spades).

Many different games can be played using a standard deck of playing cards. The game being played with the standard deck of cards may include other items, such as game boards, chips, etc., or the game being played may only need the playing card deck itself. In most of the games played using a standard deck of cards, a value is assigned to each card. The value may differ for different games.

Usually, the card value begins with the number two card as the lowest value and increases as the numbers increase through ten, followed in order of increasing value with the Jack, Queen, King and Ace. In some games the Ace may have a lower value than the two, and in games where a particular card is determined to be wild, or have any value, that card may have the greatest value of all. For example, in card games where deuces, or twos, are wild, the player holding a playing card containing a two can use that two as any other card, such that a nine and a two would be the equivalent of two nines.

Further, the four different suits indicated on the cards may have a particular value depending on the game. Under game rules where one suit, i.e., Spades, has more value than another suit, i.e., Hearts, the seven of Spades may have more value than the seven of Hearts.

It is easy to visualize that using the different card quantity and suit values, many different games can be played. In certain games, it is the combination of cards that one player obtains that determines whether or not that player has defeated the other player or players. Usually, the more difficult the combination is to obtain, the more value the combination has, and the player who obtains the more difficult combination (also taking into account the value of the cards) wins the game.

For instance in the game of Poker, each player may ultimately receive five cards. The player who obtains three cards having similar numbers on their face, i.e., the four of Hearts, four of Diamonds and four of Clubs, will defeat the player having only two cards with the same numerical value, i.e., the King of Spades and the King of Hearts. However, the player with five cards that all contain Clubs, commonly known as a flush, will defeat the player with the same three of a kind described above.

In many instances, a standard deck of playing cards is used to create gaming machines. In these gaming machines players insert coins and play certain card games, such as poker, using an imitation of standard playing cards on a video screen, in an attempt to win back more money than they originally inserted into the machine.

Another form of gambling using playing cards utilizes tables, otherwise known as table games. A table uses a table and a dealer, with the players sitting or standing around the table. The players place their bets on the table and the dealer deals the cards to each player. The number of cards dealt, or whether the cards are dealt face up or face down, will depend on the particular table game being played.

Further, an imitation or depiction of a standard playing card is used in many handheld electronic games, such as poker and blackjack, and in many computer games and Internet games. Using a handheld electronic game or a computer terminal that may or may not be connected to the Internet, a player receives the imitation playing cards and plays a card game either against the computer or against other players. Further, many of these games can be played on the computer in combination with gambling.

Also, there are many game shows that are broadcasted on television that use a deck of playing cards in the game play, in which the cards are usually enlarged or shown on a video screen or monitor for easy viewing. In these television game shows, the participants play the card game for prizes or money, usually against each other, with an individual acting as a host overseeing the action.

Also, there are lottery tickets that players purchase and play by “scratching off” an opaque layer to see if they have won money and prizes. The opaque layer prevents the player from knowing the results of the lottery ticket prior to purchasing and scratching off the layer. In some of these lottery tickets, playing cards are used under the opaque layer and the player may need to match a number of similar cards in order to win the prizes or money.

### XIII. Rules of Card Games

### Rules of Poker

In a basic poker game, which is played with a standard 52-card deck, each player is dealt five cards. All five cards in each player's hand are evaluated as a single hand with the presence of various combinations of the cards such as pairs, three-of-a-kind, straight, etc.

Determining which combinations prevail over other combinations is done by reference to a table containing a ranking of the combinations. Rankings in most tables are based on the odds of each combination occurring in the player's hand. Regardless of the number of cards in a player's hand, the values assigned to the cards, and the odds, the method of evaluating all five cards in a player's hand remain the same.

Poker is a popular skill-based card game in which players with fully or partially concealed cards make wagers into a central pot. The pot is awarded to the player or players with the best combination of cards or to the player who makes an uncalled bet. Poker can also refer to video poker, a single-player game seen in casinos much like a slot machine, or to other games that use poker hand rankings.

Poker is played in a multitude of variations, but most follow the same basic pattern of play.

The right to deal each hand typically rotates among the players and is marked by a token called a ‘dealer’ button or buck. In a casino, a house dealer handles the cards for each hand, but a button (typically a white plastic disk) is rotated clockwise among the players to indicate a nominal dealer to determine the order of betting.

For each hand, one or more players are required to make forced bets to create an initial stake for which the players will contest. The dealer shuffles the cards, he cuts, and the appropriate number of cards are dealt to the players one at a time. Cards may be dealt either face-up or face-down, depending on the variant of poker being played. After the initial deal, the first of what may be several betting rounds begins. Between rounds, the players' hands develop in some way, often by being dealt additional cards or replacing cards previously dealt. At the end of each round, all bets are gathered into the central pot.

At any time during a betting round, if a player makes a bet, opponents are required to fold, call or raise. If one player bets and no opponents choose to match the bet, the hand ends immediately, the bettor is awarded the pot, no cards are required to be shown, and the next hand begins. The ability to win a pot without showing a hand makes bluffing possible. Bluffing is a primary feature of poker, one that distinguishes it from other vying games and from other games that make use of poker hand rankings.

At the end of the last betting round, if more than one player remains, there is a showdown, in which the players reveal their previously hidden cards and evaluate their hands. The player with the best hand according to the poker variant being played wins the pot.

The most popular poker variants are as follows:

Draw Poker

Players each receive five—as in five-card draw—or more cards, all of which are hidden. They can then replace one or more of these cards a certain number of times.

Stud Poker

Players receive cards one at a time, some being displayed to other players at the table. The key difference between stud and ‘draw’ poker is that players are not allowed to discard or replace any cards.

Community Card Poker

Players combine individually dealt cards with a number of “community cards” dealt face up and shared by all players. Two or four individual cards may be dealt in the most popular variations, Texas hold 'em and Omaha hold 'em, respectively.

### Poker Hand Rankings

Straight Flush

A straight flush is a poker hand such as Q [symbol] J [symbol] 10 [symbol] 9 [symbol] 8 [symbol] , which contains five cards in sequence, all of the same suit. Two such hands are compared by their high card in the same way as are straights. The low ace rule also applies: 5└ 4♦ 3♦ 2♦ A♦ is a 5-high straight flush (also known as a “steel wheel”). An ace-high straight flush such as A [symbol] K [symbol] Q [symbol] J [symbol] 10 [symbol] is known as a royal flush, and is the highest ranking standard poker hand (excluding five of a kind).

Examples:

7♡ 6♡ 5♡ 4♡ 3♡ beats 5 [symbol] 4 [symbol] 3 [symbol] 2 [symbol] A

[symbol]

J [symbol] 10 [symbol] 9 [symbol] 8 [symbol] 7 [symbol] ties J♦ 10♦ 9♦ 8♦ 7♦

Four of a Kind

Four of a kind, or quads, is a poker hand such as 9 [symbol] 9 [symbol] 9♦ 9♡ J♡, which contains four cards of one rank, and an unmatched card. It ranks above a full house and below a straight flush. Higher ranking quads defeat lower ranking ones. Between two equal sets of four of a kind (possible in wild card and community card games), the kicker determines the winner.

Examples:

10 [symbol] 10♦ 10♡ 10 [symbol] 5♦ (“four tens” or “quad tens”) defeats 6♦ 6♡ 6 [symbol] 6 [symbol] K [symbol] (“four sixes” or “quad sixes”)

10 [symbol] 10♦ 10♡ 10 [symbol] Q [symbol] (“four tens, queen kicker”) defeats 10 [symbol] 10♦ 10♡ 10 [symbol] 5♦ (“four tens with a five”)

Full House

A full house, also known as a boat or a full boat, is a poker hand such as 3 [symbol] 3 [symbol] 3♦ 6 [symbol] 6♡, which contains three matching cards of one rank, plus two matching cards of another rank. It ranks below a four of a kind and above a flush. Between two full houses, the one with the higher ranking set of three wins. If two have the same set of three (possible in wild card and community card games), the hand with the higher pair wins. Full houses are described by the three of a kind (e.g. Q-Q-Q) and pair (e.g. 9-9), as in “Queens over nines” (also used to describe a two pair), “Queens full of nines” or simply “Queens full”.

Examples:

10 [symbol] 10♡ 10♦ 4 [symbol] 4♦ (“tens full”) defeats 9♡ 9 [symbol] 9 [symbol] A♡ A [symbol] (“nines full”)

K [symbol] K [symbol] K♡ 3♡ 3 [symbol] (“kings full”) defeats 3 [symbol] 3♡ 3♦ K [symbol] K♦ (“threes full”)

Q♡ Q♦ Q [symbol] 8♡ 8 [symbol] (“queens full of eights”) defeats Q♡ Q♦ Q [symbol] 5 [symbol] 5♡ (“queens full of fives”)

Flush

A flush is a poker hand such as Q [symbol] 10 [symbol] 7 [symbol] 6 [symbol] 4 [symbol] , which contains five cards of the same suit, not in rank sequence. It ranks above a straight and below a full house. Two flushes are compared as if they were high card hands. In other words, the highest ranking card of each is compared to determine the winner; if both have the same high card, then the second-highest ranking card is compared, etc. The suits have no value: two flushes with the same five ranks of cards are tied. Flushes are described by the highest card, as in “queen-high flush”.

Examples:

A♡ Q♡ 10♡ 5♡ 3♡ (“ace-high flush”) defeats K [symbol] Q [symbol] J [symbol] 9 [symbol] 6 [symbol] (“king-high flush”)

A♦ K♦ 7♦ 6♦ 2♦ (“flush, ace-king high”) defeats A♡ Q♡ 10♡ 5♡ 3♡ (“flush, ace-queen high”)

Q♡ 10♡ 9♡ 5♡ 2♡ (“heart flush”) ties Q [symbol] 10 [symbol] 9 [symbol] 5 [symbol] 2 [symbol] (“spade flush”)

Straight

A straight is a poker hand such as Q [symbol] J [symbol] 10 [symbol] 9♡ 8♡, which contains five cards of sequential rank, of varying suits. It ranks above three of a kind and below a flush. Two straights are ranked by comparing the high card of each. Two straights with the same high card are of equal value, and split any winnings (straights are the most commonly tied hands in poker, especially in community card games). Straights are described by the highest card, as in “queen-high straight” or “straight to the queen”.

A hand such as A [symbol] K [symbol] Q♦ J [symbol] 10 [symbol] is an ace-high straight, and ranks above a king-high straight such as K♡ Q [symbol] 10♡ 9♦. But the ace may also be played as a 1-spot in a hand such as 5 [symbol] 4♦ 3♦ 2 [symbol] A [symbol] , called a wheel or five-high straight, which ranks below the six-high straight 6 [symbol] 5 [symbol] 4 [symbol] 3♡ 2♦. The ace may not “wrap around”, or play both high and low in the same hand: 3 [symbol] 2♦ A [symbol] [symbol] Q [symbol] is not a straight, but just ace-high no pair.

Examples:

8 [symbol] 7 [symbol] 6♡ 5♡ 4 [symbol] (“eight-high straight”) defeats 6♦ 5 [symbol] 4♦ 3♡ 2 [symbol] (“six-high straight”)

8 [symbol] 7 [symbol] 6♡ 5♡ 4 [symbol] ties 8♡ 7♦ 6 [symbol] 5 [symbol] 4♡

Three of a Kind

Three of a kind, also called trips, set or a prile, is a poker hand such as 2♦ 2 [symbol] 2♡ K [symbol] 6 [symbol] , which contains three cards of the same rank, plus two unmatched cards. It ranks above two pair and below a straight. Higher ranking three of a kind defeat lower ranking three of a kinds. If two hands have the same rank three of a kind (possible in games with wild cards or community cards), the kickers are compared to break the tie.

Examples:

8 [symbol] 8♡ 8♦ 5 [symbol] 3 [symbol] (“three eights”) defeats 5 [symbol] 5♡ 5♦ Q♦ 10 [symbol] (“three fives”)

8 [symbol] 8♡ 8♦ A [symbol] 2♦ (“three eights, ace kicker”) defeats 8 [symbol] 8♡ 8♦ 5 [symbol] 3 [symbol] (“three eights, five kicker”)

Two Pair

A poker hand such as J♡ J [symbol] 4 [symbol] 4 [symbol] 9 [symbol] , which contains two cards of the same rank, plus two cards of another rank (that match each other but not the first pair), plus one unmatched card, is called two pair. It ranks above one pair and below three of a kind. Between two hands containing two pair, the higher ranking pair of each is first compared, and the higher pair wins. If both have the same top pair, then the second pair of each is compared. Finally, if both hands have the same two pairs, the kicker determines the winner. Two pair are described by the higher pair (e.g., K♡ K [symbol] ) and the lower pair (e.g., 9 [symbol] 9♦), as in “Kings over nines”, “Kings and nines” or simply “Kings up”.

Examples:

K♡ K♦ 2 [symbol] 2♦ J♡ (“kings up”) defeats J♦ J [symbol] 10 [symbol] 10 [symbol] 9 [symbol] (“jacks up”)

9 [symbol] 9♦ 7♦ 7 [symbol] 6♡ (“nines and sevens”) defeats 9♡ 9 [symbol] 5♡ 5♦ K [symbol] (“nines and fives”) 4 [symbol] 4 [symbol] 3 [symbol] 3♡ K♦ (“fours and threes, king kicker”) defeats 4♡ 4♦ 3♦ 3 10 [symbol] (“fours and threes with a ten”)

One Pair

One pair is a poker hand such as 4♡4 [symbol] K [symbol] 10♦ 5 [symbol] , which contains two cards of the same rank, plus three unmatched cards. It ranks above any high card hand, but below all other poker hands. Higher ranking pairs defeat lower ranking pairs. If two hands have the same rank of pair, the non-paired cards in each hand (the kickers) are compared to determine the winner.

Examples:

10 [symbol] 10 [symbol] 6 [symbol] 4♡ 2♡ (“pair of tens”) defeats 9♡ 9 [symbol] A♡ Q♦ 10♦ (“pair of nines”)

10♡ 10♦ J♦ 3♡ 2 [symbol] (“tens with jack kicker”) defeats 10 [symbol] 10 [symbol] 6 [symbol] 4♡ 2♡ (“tens with six kicker”)

2♦ 2♡ 8 [symbol] [symbol] 4 [symbol] (“deuces, eight-five-four”) defeats 2 [symbol] 2 [symbol] 8 [symbol] 5♡ 3♡ (“deuces, eight-five-three”)

High Card

A high-card or no-pair hand is a poker hand such as K♡ J [symbol] 8 [symbol] 7♦ 3 [symbol] , in which no two cards have the same rank, the five cards are not in sequence, and the five cards are not all the same suit. It can also be referred to as “nothing” or “garbage,” and many other derogatory terms. It ranks below all other poker hands. Two such hands are ranked by comparing the highest ranking card; if those are equal, then the next highest ranking card; if those are equal, then the third highest ranking card, etc. No-pair hands are described by the one or two highest cards in the hand, such as “king high” or “ace-queen high”, or by as many cards as are necessary to break a tie.

Examples:

A♦ 10♦ 9 [symbol] 5 [symbol] 4 [symbol] (“ace high”) defeats K [symbol] Q♦ J [symbol] 8♡ 7♡ (“king high”)

A [symbol] Q [symbol] 7♦ 5♡ 2 [symbol] (“ace-queen”) defeats A♦ 10 [symbol] 5 [symbol] 4 [symbol] (“ace-ten”)

7 [symbol] 6 [symbol] 5 [symbol] 4♦ 2♡ (“seven-six-five-four”) defeats 7 [symbol] 6♦ 5♦ 3♡ 2 [symbol] (“seven-six-five-three”)

Decks Using a Bug

The use of joker as a bug creates a slight variation of game play. When a joker is introduced in standard poker games it functions as a fifth ace, or can be used as a flush or straight card (though it can be used as a wild card too). Normally casino draw poker variants use a joker, and thus the best possible hand is five of a kind, as in A♡ A♦ A [symbol] A [symbol] Joker.

### Rules of Caribbean Stud

Caribbean Stud™ poker may be played as follows. A player and a dealer are each dealt five cards. If the dealer has a poker hand having a value less than Ace-King combination or better, the player automatically wins. If the dealer has a poker hand having a value of an Ace-King combination or better, then the higher of the player's or the dealer's hand wins. If the player wins, he may receive an additional bonus payment depending on the poker rank of his hand. In the commercial play of the game, a side bet is usually required to allow a chance at a progressive jackpot. In Caribbean Stud™ poker, it is the dealer's hand that must qualify. As the dealer's hand is partially concealed during play (usually only one card, at most) is displayed to the player before player wagering is complete), the player must always be aware that even ranked player hands can lose to a dealer's hand and no bonus will be paid out unless the side bet has been made, and then usually only to hands having a rank of a flush or higher.

### Rules of Blackjack

Some versions of Blackjack are now described. Blackjack hands are scored according to the point total of the cards in the hand. The hand with the highest total wins as long as it is 21 or less. If the total is greater than 21, it is a called a “bust.” Numbered cards 2 through 10 have a point value equal to their face value, and face cards (i.e., Jack, Queen and King) are worth 10 points. An Ace is worth 11 points unless it would bust a hand, in which case it is worth 1 point. Players play against the dealer and win by having a higher point total no greater than 21. If the player busts, the player loses, even if the dealer also busts. If the player and dealer have hands with the same point value, this is called a “push,” and neither party wins the hand.

After the initial bets are placed, the dealer deals the cards, either from one or more, but typically two, hand-held decks of cards, or from a “shoe” containing multiple decks of cards, generally at least four decks of cards, and typically many more. A game in which the deck or decks of cards are hand-held is known as a “pitch” game. “Pitch” games are generally not played in casinos. When playing with more than one deck, the decks are shuffled together in order to make it more difficult to remember which cards have been dealt and which have not. The dealer deals two cards to each player and to himself. Typically, one of the dealer's two cards is dealt face-up so that all players can see it, and the other is face down. The face-down card is called the “hole card.” In a European variation, the “hole card” is dealt after all the players' cards are dealt and their hands have been played. The players' cards are dealt face up from a shoe and face down if it is a “pitch” game.

A two-card hand with a point value of 21 (i.e., an Ace and a face card or a 10) is called a “Blackjack” or a “natural” and wins automatically. A player with a “natural” is conventionally paid 3:2 on his bet, although in 2003 some Las Vegas casinos began paying 6:5, typically in games with only a single deck.

Once the first two cards have been dealt to each player and the dealer, the dealer wins automatically if the dealer has a “natural” and the player does not. If the player has a “natural” and the dealer does not, the player automatically wins. If the dealer and player both have a “natural,” neither party wins the hand.

If neither side has a “natural,” each player completely plays out their hand; when all players have finished, the dealer plays his hand.

The playing of the hand typically involves a combination of four possible actions “hitting,” “standing,” “doubling down,” or “splitting” his hand. Often another action called “surrendering” is added. To “hit” is to take another card. To “stand” is to take no more cards. To “double down” is to double the wager, take precisely one more card and then “stand.”When a player has identical value cards, such as a pair of 8s, the player can “split” by placing an additional wager and playing each card as the first card in two new hands. To “surrender” is to forfeit half the player's bet and give up his hand. “Surrender” is not an option in most casino games of Blackjack. A player's turn ends if he “stands,” “busts” or “doubles down.” If the player “busts,” he loses even if the dealer subsequently busts. This is the house advantage.

After all players have played their hands, the dealer then reveals the dealer's hole card and plays his hand. According to house rules (the prevalent casino rules), the dealer must hit until he has a point total of at least 17, regardless of what the players have. In most casinos, the dealer must also hit on a “soft” 17 (e.g., an Ace and 6). In a casino, the Blackjack table felt is marked to indicate if the dealer hits or stands on a soft 17. If the dealer busts, all remaining players win. Bets are normally paid out at odds of 1:1.

Four of the common rule variations are one card split Aces, early surrender, late surrender and double-down restrictions. In the first variation, one card is dealt on each Ace and the player's turn is over. In the second, the player has the option to surrender before the dealer checks for Blackjack. In the third, the player has the option to surrender after the dealer checks for Blackjack. In the fourth, doubling-down is only permitted for certain card combinations.

### Insurance

Insurance is a commonly-offered betting option in which the player can hedge his bet by wagering that the dealer will win the hand. If the dealer's “up card” is an Ace, the player is offered the option of buying Insurance before the dealer checks his “hole card.” If the player wishes to take Insurance, the player can bet an amount up to half that of his original bet. The Insurance bet is placed separately on a special portion of the table, which is usually marked with the words “Insurance Pays 2:1.” The player buying Insurance is betting that the dealer's “hole card” is one with a value of 10 (i.e., a 10, Jack, Queen or King). Because the dealer's up card is an Ace, the player who buys Insurance is betting that the dealer has a “natural.”

If the player originally bets $10 and the dealer shows an Ace, the player can buy Insurance by betting up to $5. Suppose the player makes a $5 Insurance bet and the player's hand with the two cards dealt to him totals 19. If the dealer's hole card is revealed to be a 10 after the Insurance betting period is over (the dealer checks for a “natural” before the players play their hands), the player loses his original $10 bet, but he wins the $5 Insurance bet at odds of 2:1, winning $10 and therefore breaking even. In the same situation, if the dealer's hole card is not one with a value of ten, the player immediately loses his $5 Insurance bet. But if the player chooses to stand on 19, and if the dealer's hand has a total value less than 19, at the end of the dealer's turn, the player wins his original $10 bet, making a net profit of $5. In the same situation, if the dealer's hole card is not one with a value of ten, again the player will immediately lose their $5 Insurance bet, and if the dealer's hand has a total value greater than the player's at the end of both of their turns, for example the player stood on 19 and the dealer ended his turn with 20, the player loses both his original $10 bet and his $5 Insurance bet.

### Basic Strategy

Blackjack players can increase their expected winnings by several means, one of which is “basic strategy.” “Basic strategy” is simply something that exists as a matter of general practice; it has no official sanction. The “basic strategy” determines when to hit and when to stand, as well as when doubling down or splitting in the best course. Basic strategy is based on the player's point total and the dealer's visible card. Under some conditions (e.g., playing with a single deck according to downtown Las Vegas rules) the house advantage over a player using basic strategy can be as low as 0.16%. Casinos offering options like surrender and double-after-split may be giving the player using basic strategy a statistical advantage and instead rely on players making mistakes to provide a house advantage.

A number of optional rules can benefit a skilled player, for example: if doubling down is permitted on any two-card hand other than a natural; if “doubling down” is permitted after splitting; if early surrender (forfeiting half the bet against a face or Ace up card before the dealer checks for Blackjack) is permitted; if late surrender is permitted; if re-splitting Aces is permitted (splitting when the player has more than two cards in their hand, and has just been dealt a second ace in their hand); if drawing more than one card against a split Ace is permitted; if five or more cards with a total no more than 21 is an automatic win (referred to as “Charlies”).

Other optional rules can be detrimental to a skilled player. For example: if a “natural” pays less than 3:2 (e.g., Las Vegas Strip single-deck Blackjack paying out at 6:5 for a “natural”); if a hand can only be split once (is re-splitting possible for other than aces); if doubling down is restricted to certain totals (e.g., 9 11 or 10 11); if Aces may not be re-split; if the rules are those of “no-peek” (or European) Blackjack, according to which the player loses hands that have been split or “doubled down” to a dealer who has a “natural’ (because the dealer does not check for this automatically winning hand until the players had played their hands); if the player loses ties with the dealer, instead of pushing where neither the player or the dealer wins and the player retains their original bet.

### Card Counting

Unlike some other casino games, in which one play has no influence on any subsequent play, a hand of Blackjack removes those cards from the deck. As cards are removed from the deck, the probability of each of the remaining cards being dealt is altered (and dealing the same cards becomes impossible). If the remaining cards have an elevated proportion of 10-value cards and Aces, the player is more likely to be dealt a natural, which is to the player's advantage (because the dealer wins even money when the dealer has a natural, while the player wins at odds of 3:2 when the player has a natural). If the remaining cards have an elevated proportion of low-value cards, such as 4s, 5s and 6s, the player is more likely to bust, which is to the dealer's advantage (because if the player busts, the dealer wins even if the dealer later busts).

The house advantage in Blackjack is relatively small at the outset. By keeping track of which cards have been dealt, a player can take advantage of the changing proportions of the remaining cards by betting higher amounts when there is an elevated proportion of 10-value cards and Aces and by better lower amounts when there is an elevated proportion of low-value cards. Over time, the deck will be unfavorable to the player more often than it is favorable, but by adjusting the amounts that he bets, the player can overcome that inherent disadvantage. The player can also use this information to refine basic strategy. For instance, basic strategy calls for hitting on a 16 when the dealer's up card is a 10, but if the player knows that the deck has a disproportionately small number of low-value cards remaining, the odds may be altered in favor of standing on the 16.

There are a number of card-counting schemes, all dependent for their efficacy on the player's ability to remember either a simplified or detailed tally of the cards that have been played. The more detailed the tally, the more accurate it is, but the harder it is to remember. Although card counting is not illegal, casinos will eject or ban successful card counters if they are detected.

Shuffle tracking is a more obscure, and difficult, method of attempting to shift the odds in favor of the player. The player attempts to track groups of cards during the play of a multi-deck shoe, follow them through the shuffle, and then looks for the same group to reappear from the new shoe, playing and betting accordingly.

### XIV. Casino Countermeasures

Some methods of thwarting card counters include using a large number of decks. Shoes containing 6 or 8 decks are common. The more cards there are, the less variation there is in the proportions of the remaining cards and the harder it is to count them. The player's advantage can also be reduced by shuffling the cards more frequently, but this reduces the amount of time that can be devoting to actual play and therefore reduces the casino profits. Some casinos now use shuffling machines, some of which shuffle one set of cards while another is in play, while others continuously shuffle the cards. The distractions of the gaming floor environment and complimentary alcoholic beverages also act to thwart card counters. Some methods of thwarting card counters include using varied payoff structures, such Blackjack payoff of 6:5, which is more disadvantageous to the player than the standard 3:2 Blackjack payoff.

### XV. Video Wagering Games

Video wagering games are set up to mimic a table game using adaptations of table games rules and cards.

In one version of video poker the player is allowed to inspect five cards randomly chosen by the computer. These cards are displayed on the video screen and the player chooses which cards, if any, that he or she wishes to hold. If the player wishes to hold all of the cards, i.e., stand, he or she presses a STAND button. If the player wishes to hold only some of the cards, he or she chooses the cards to be held by pressing HOLD keys located directly under each card displayed on the video screen. Pushing a DEAL button after choosing the HOLD cards automatically and simultaneously replaces the unchosen cards with additional cards which are randomly selected from the remainder of the deck. After the STAND button is pushed, or the cards are replaced, the final holding is evaluated by the game machine's computer and the player is awarded either play credits or a coin payout as determined from a payoff table. This payoff table is stored in the machine's computer memory and is also displayed on the machine's screen. Hands with higher poker values are awarded more credits or coins. Very rare poker hands are awarded payoffs of 800-to-1 or higher.

### XVI. Apparatus for Playing Over a Communications System

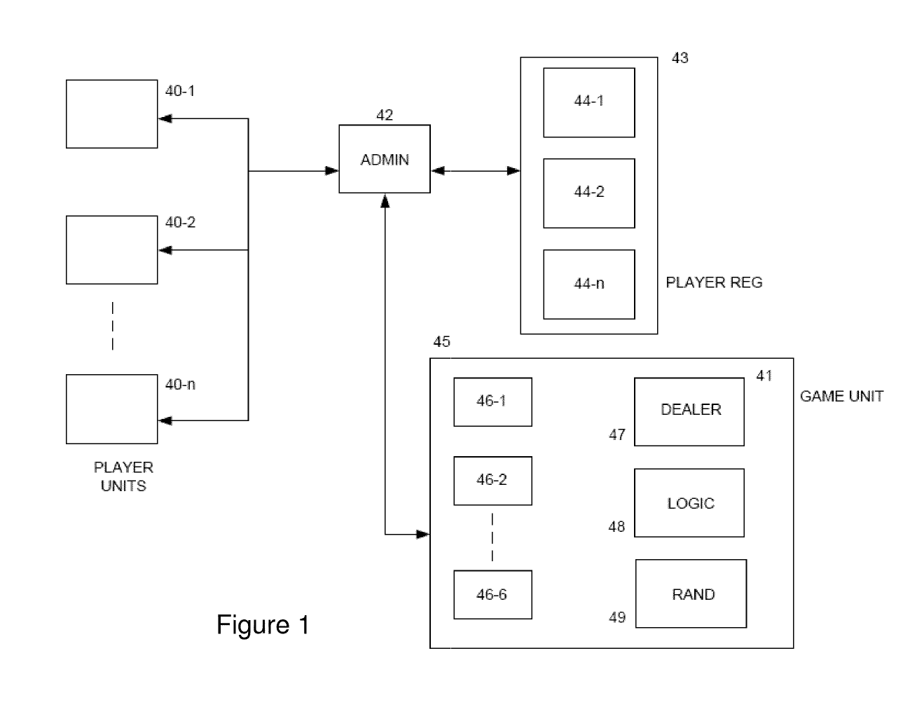

FIG. 1 shows apparatus for playing the game. There is a plurality of player units 40-1 to 40-n which are coupled via a communication system 41, such as the Internet, with a game playing system comprising an administration unit 42, a player register 43, and a game unit 45. Each unit 40 is typically a personal computer with a display unit and control means (a keyboard and a mouse).

When a player logs on to the game playing system, their unit 40 identifies itself to the administration unit. The system holds the details of the players in the register 43, which contains separate player register units 44-1 to 44-n for all the potential players, i.e., for all the members of the system.

Once the player has been identified, the player is assigned to a game unit 45. The game unit contains a set of player data units 46-1 to 46-6, a dealer unit 47, a control unit 48, and a random dealing unit 49.

Up to seven players can be assigned to the game unit 45. There can be several such units, as indicated, so that several games can be played at the same time if there are more than seven members of the system logged on at the same time. The assignment of a player unit 40 to a player data unit 46 may be arbitrary or random, depending on which player data units 46 and game units 45 are free. Each player data unit 46 is loaded from the corresponding player register unit 44 and also contains essentially the same details as the corresponding player unit 40, and is in communication with the player unit 40 to keep the contents of the player unit and player data unit updated with each other. In addition, the appropriate parts of the contents of the other player data units 46 and the dealer unit 47 are passed to the player unit 40 for display.

The logic unit 48 of the game unit 45 steps the game unit through the various stages of the play, initiating the dealer actions and awaiting the appropriate responses from the player units 40. The random dealing unit 49 deals cards essentially randomly to the dealer unit 47 and the player data units 46. At the end of the hand, the logic unit passes the results of the hand, i.e., the wins and/or losses, to the player data units 46 to inform the players of their results. The administrative unit 42 also takes those results and updates the player register units 44 accordingly.

The player units 40 are arranged to show a display. To identify the player, the player's position is highlighted. As play proceeds, so the player selects the various boxes, enters bets in them, and so on, and the results of those actions are displayed. As the cards are dealt, a series of overlapping card symbols is shown in the Bonus box. At the option of the player, the cards can be shown in a line below the box, and similarly for the card dealt to the dealer. At the end of the hand, a message is displayed informing the player of the results of their bets, i.e., the amounts won or lost.

### XVII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

### XVIII. References

The following patents and patent applications are hereby incorporated by reference herein for all purposes: U.S. Pat. No. 6,579,181, U.S. Pat. No. 6,299,536, U.S. Pat. No. 6,093,103, U.S. Pat. No. 5,941,769, U.S. Pat. No. 7,114,718, U.S. patent application Ser. No. 10/622,321, U.S. Pat. No. 4,515,367, U.S. Pat. No. 5,000,453, U.S. Pat. No. 7,137,630, and U.S. Pat. No. 7,137,629.

What is claimed is:

1. A method comprising:
receiving, by a computing device, a set of participants chosen by a user;
receiving, by the computing device, an accomplishment chosen by the user;
determining, by the computing device, odds for a game that is based on whether the set of participants will achieve the accomplishment in a plurality of events, in which the odds determination is based on historic data about performance of the participants;
offering, by the computing device, the game for play with the odds to the user;
receiving, by the computing device, an acceptance of the offer from the user that identifies an amount of money risked through play of the game;
determining, by the computing device, an outcome of the game based on whether the set of participants achieved the accomplishment in the plurality of events; and
determining, by the computing device, whether to provide a payment to the user based on the outcome.

2. The method of claim 1, in which the set of participants are players from across a plurality of events.

3. The method of claim 1, in which the events include sporting events.

4. The method of claim 1, in which the game includes a fantasy sports game.

5. The method of claim 1, in which the historic data includes information indicative of each participant's ability to contribute to the accomplishment in prior events to the plurality of events.

6. The method of claim 1, in which offering includes presenting information about the odds to the user through a user interface of a mobile device.

7. The method of claim 1, in which the outcome includes winning the game if the participants achieved the accomplishment and a determination to provide the payment is made in response to the determination that the outcome includes winning the game.

8. The method of claim 1, further comprising receiving an amount of money to play the game from the user.

9. The method of claim 1, in which the accomplishment includes a number of points earned in total by the set of players in the plurality of events.

10. The method of claim 1, further comprising providing the payment to the user.

11. The method of claim 1, in which the set of participants includes a plurality of participants.

12. The method of claim 11, in which each participant plays in only one of the plurality of events and the set of participants collectively plays in all of the plurality of events

13. The method of claim 11, in which the accomplishment includes a plurality of accomplishments that each apply to a single respective one of the plurality of participants.

14. The method of claim 13, in which the outcome is a winning outcome if each participant achieved the single respective accomplishment of the plurality of accomplishments that applies to the participant.

15. The method of claim 1, in which the accomplishment includes achievement of a goal in a designated time period.

16. The method of claim 15, in which the outcome is a winning game if the goal is achieved in less than the time period.

17. An apparatus comprising:
a computing device; and
a non-transitory medium having stored thereon a plurality of instructions that when executed by the computing device causes the computing device to:
receive a set of participants chosen by a user;
receive an accomplishment chosen by the user;
determine odds for a wager that the set of participants will achieve the accomplishment in a plurality of events, in which determining the odds includes determining based on historic data about performance of the participants;
offer the wager with the odds to the user;
receive an acceptance of the wager from the user that identifies an amount of money wagered;
determine an outcome of the wager based on whether the set of participants achieve the accomplishment in the plurality of events; and
provide a payment to the user based on the outcome.
